(19) United States
(12) Patent Application Publication
(10) Pub. No.: US 2013/0313857 A1
(43) Pub. Date: Nov. 28, 2013

(54) WOOD FLOORING WITH PROTECTIVE COATING FOR TRUCK TRAILERS AND CONTAINERS

(71) Applicant: ZIQIANG LU, RED WING, MN (US)

(72) Inventor: ZIQIANG LU, RED WING, MN (US)

(73) Assignee: INDUSTRIAL HARDWOOD PRODUCTS, INC., RED WING, MN (US)

(21) Appl. No.: 13/477,800

(22) Filed: May 22, 2012

(51) Int. Cl. B62D 25/20; B27F 7/00

(52) U.S. Cl. 296/184.1; 144/344

(57) ABSTRACT

Floor boards and wood flooring for truck trailers and containers as well as methods for making and using the same are disclosed. An example wood floor for truck trailers and containers may include a wood member having a top surface and a bottom surface. The wood member may include a plurality of wood strips that are attached together. A coating essentially impermeable to liquid water and water vapor may cover the bottom surface. The coating may include crosslinking polyvinyl acetate.

### FIELD OF THE INVENTION

The present invention pertains to wood flooring. More particularly, the present invention pertains to wood flooring for truck trailers and containers.

### BACKGROUND

Conventional truck trailers may utilize wood flooring, for example hardwood flooring, because of the desirable characteristics that the flooring may provide the trailer. For example, hardwood flooring may have a desirable level of strength and stiffness. This may give the flooring a long life and increase its wear resistance. Of the known wood floorings, each has certain advantages and disadvantages. There is an ongoing need to provide additional floorings and methods for making and using floorings.

### BRIEF SUMMARY

The invention provides design, material, manufacturing method, and use alternatives for floor boards and/or wood floors for truck trailers and containers. An example wood floor for truck trailers and containers may include a wood member having a top surface and a bottom surface. The wood member may include a plurality of wood strips that are attached together. A coating essentially impermeable to liquid water and water vapor may cover the bottom surface. The coating may include crosslinking polyvinyl acetate.

Another example wood floor for truck trailers and containers is also disclosed. The wood floor may having a bottom surface and may include a plurality of floor boards. Each of the floor boards may include a plurality of wood strips that are attached together. A coating may cover the bottom surface. The coating may include crosslinking polyvinyl acetate.

An example method for manufacturing a wood floor is also disclosed. The method may include providing a plurality of wood strips, attaching the wood strips together to form a floor board, coating a bottom surface of the floor board with crosslinking polyvinyl acetate, and forming a wood floor by joining together two or more floor boards.

The above summary of some embodiments is not intended to describe each disclosed embodiment or every implementation of the present invention. The Figures, and Detailed Description, which follow, more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a plan overview illustrating an example wood floor disposed in a truck trailer;

FIG. 2 is a perspective view of a portion of an example wood floor;

FIG. 3 is a side view of a portion of a wood member illustrating a hook joint;

FIG. 4 is an end view of a portion of an example wood floor with a coating;

FIG. 4A is a portion of a wood member with a coating along the bottom surface thereof;

FIG. 4B is a portion of a wood member with a coating along the bottom surface and side surfaces thereof;

FIG. 5 is an end view of a portion of an example wood floor with a coating along the end surfaces thereof; and

FIGS. 6-13 illustrate example methods for manufacturing a coated wood floor.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The drawings, which are not necessarily to scale, depict illustrative embodiments and are not intended to limit the scope of the invention.

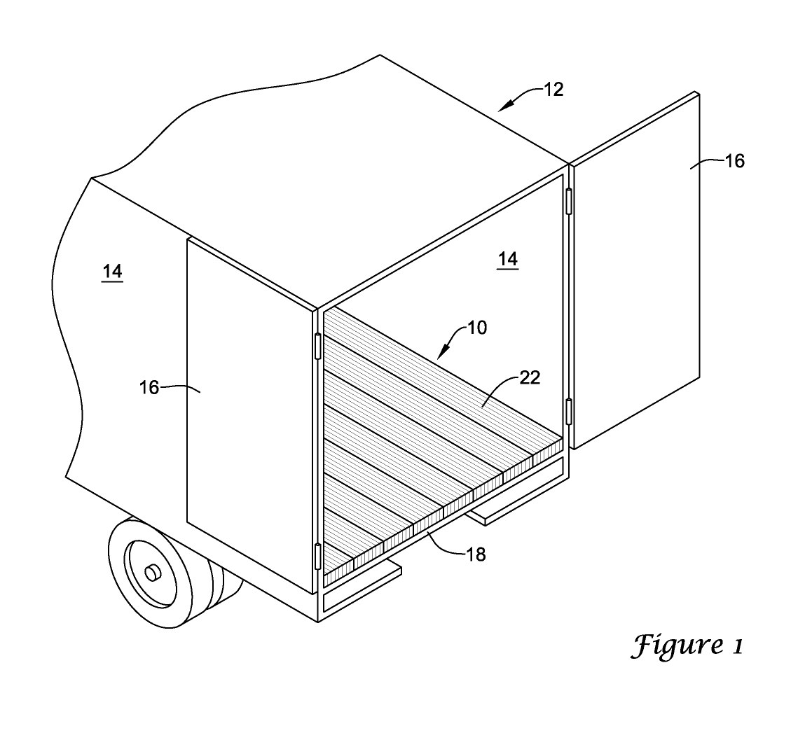

FIG. 1 is a plan view of an example wood flooring 10 disposed in a truck trailer 12. Although flooring 10 is illustrated within trailer 12, this is not intended to limit the invention as flooring 10 may be used, for example, with a number of different structures including containers (e.g., shipping and/or freight containers), railroad box cars, truck bodies, and the like, or any other suitable structure. Trailer 12 may be structurally similar to typical truck trailers. For example, trailer 12 may have a pair of opposing side walls 14 and end doors 16 that can open and close to provide access to the interior of trailer 12. In at least some embodiments, flooring 10 may extend across the width and along the length of the interior of trailer 12. Trailer 12 may have a plurality of support members 18 (e.g., “I” beams, “C” beams, hat sections, etc.) that each may have an upper flange or surface that crosses the width of trailer 12 and are spaced along the length of trailer 12. In some embodiments, flooring 10 may be secured to support member 18 by screws (not shown) or any other suitable fastener, which may penetrate through the whole thickness of flooring 10 and the upper flange of support members 18.

Flooring 10 may include one or more floorboards or wood members 22. Wood members 22 may take the form of a floor board of flooring component that is made from a suitable hardwood such as oak, maple (including sugar maple), ash, birch, beech, aspen, elm, poplar, apitong, kapur, para angelim, and the like, or any other suitable hardwood. Hardwoods may be desirable, for example, due to their high strength, stiffness, and excellent durability. Alternatively, some softer woods may also be used, where appropriate.

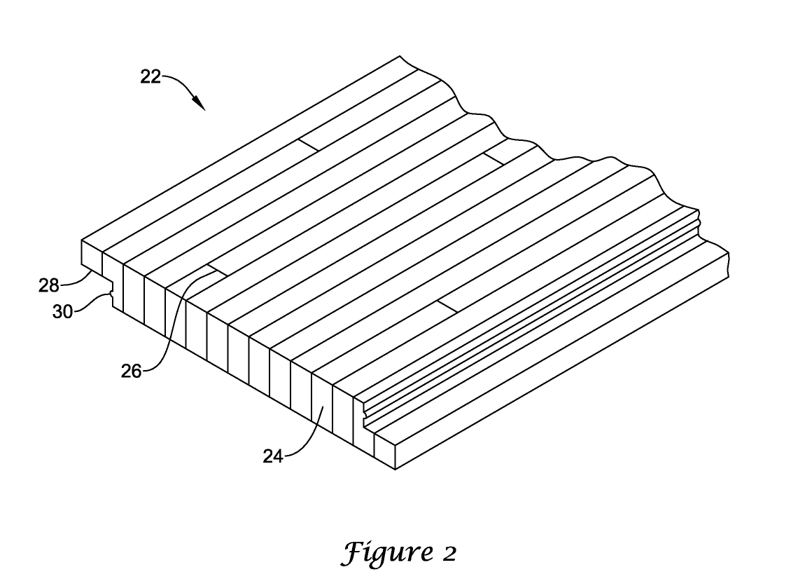

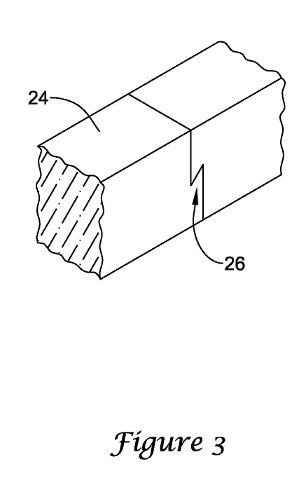

Each wood member 22 may include a plurality of wood strips 24 that are fastened together as shown in FIG. 2. For example, wood strips 24 may be arranged in a side-to-side and end-to-end manner in order to form wood member 22. To manufacture the individual strips 24, green (i.e., not dried) wood logs may be cut into lumber using conventional techniques. The lumber may be kiln-dried so that it has an equivalent moisture content of about 2 to 15%, or about 4 to 12%, or about 6 to 10%. Alternatively, the lumber may be seasoned or otherwise allowed to dry to the desired moisture content. The dried lumber may be sanded and planed into the desired thickness. For example, the lumber may be sanded and planed so that it has a thickness of about 0.75 to 1.5 inches, or about 1 to 1.25 inches thick. The lumber may also be cut into the desired width, for example, using a ripsaw. For example, the lumber may be cut to have a width of about 0.75 to 2 inches, or about 1 to 1.4375 (i.e., 1 7/16) inches wide. These are just examples.

During the manufacturing of strips 24, any wood defects such as knots, cracks and fractures, bark pockets, cavities and holes by insects, decay by fungi, and stains by molds may be cut off with, for example, a chop saw or suitable automatic cutting system. It can be appreciated that such cutting may alter the length of strips 24. It may be desirable for minimum length of wood strips 24 to be about 12 inches in wood member 22, for example. Overall, the average length of wood strips 24 may be between about three and three and one-half feet.

Both of the opposing ends of each wood strip 24 may be cut into a square shape with, for example, a tennoner saw. The squared ends of wood strips 24 may also be further cut so that “hooks” are formed therein. These hooks allow wood strips 24 to be attached end-to-end by mating adjacent hooks and forming a “hook joint” 26 as illustrated in FIG. 3. The depth or size of hook joint 26 may vary depending on the application. For example, the depth of hook joints 26 may be about 0.25 to 0.75 inches, or about 0.25 to 0.5 inches, or about 0.375 inches. These are just examples. Alternatively, any other suitable type of joint may be utilized to join together wood strips 24.

The suitably prepared wood strips 24 may also be fastened together side-to-side using any suitable attachment technique. For example, the vertical sides or edges of each wood strip 24 may be coated with an adhesive by a roller glue spreader. This may help secure wood strips 24 across the width of wood member 22. A suitable adhesive for this securing may include urea-melamine formaldehyde, melamine formaldehyde, crosslinking polyvinyl acetate, polyisocyanate, emulsion polymer isocyanate, and the like. The glue-coated wood strips 24 may be assembled (e.g., both side-to-side and end-to-end) on a conveyor. This may include manual assembly. The hook joints 26 may fasten together the adjacent ends of strips 24 to form a continuous slab, in which they are jointed end-to-end in a number of rows (as illustrated in FIG. 1). It may be desirable to control the number of hook joints 26 per square foot. For example, it may be desirable to have about 5 to 7 hook joints 26 per square foot on average. The joined collection of wood strips 24 may be placed into a steam or radio frequency (RF) hot press under vertical and cross-direction pressures for curing of the adhesive.

Once strips 24 are secured together in the desired fashion, the resultant board may be cut to the desired length. For example, the board may be cut to a length of about 56 feet (or more or less depending on the application). Additionally, the board may also be divided into a number of floorboards or wood members 22 that each has a width, for example, of about 10 to 14 inches or about 12 inches to 12.25 inches. These wood members 22 may be planed (and/or sanded) to a desired thickness. For example, wood member 22 may be planed to a thickness of about 1 to 1.5 inches, or about 1.125 inches, or about 1.3125 inches, or about 1.375 inches, etc.

Trailers like trailer 12 may include a plurality of wood members 22 joined together to form flooring 10. For example, trailer 12 may include about 6 to 10 wood members 22, or about 8 wood members 22, or more or less depending on the application. To facilitate the joining of wood members 22, shiplaps 28 and crusher beads 30 (e.g., as shown in FIG. 2), which may be similar to those known in the art, may be machined on to both edges of each wood member 22. Shiplaps 28 may be convenient for installing floorboards on truck trailers by allowing adjacent wood member 22 to overlap. Crusher beads 30 may provide spaces between adjacent wood members 22, which may protect members 22 from buckling due to their expansion in wet conditions.

As may be expected, the underside of flooring 10 may be exposed to the environment during use. For example, the underside of flooring 10 may be exposed to moisture (e.g., rain, snow, ice, etc.), road debris, dirt, and the like, which may shorten the lifespan of flooring 10. A number of approaches have been utilized to reduce, for example, moisture exposure. For example, some floors include a reinforcing underlay to provide a moisture barrier (and/or to add strength). The present disclosure provides alternative coatings and/or barriers that may be coupled to flooring 10, for example, to form a suitable moisture barrier. These coatings may also protect flooring 10 from road debris, provide desirable strength and/or flexibility characteristics, as well as provide additional benefits.

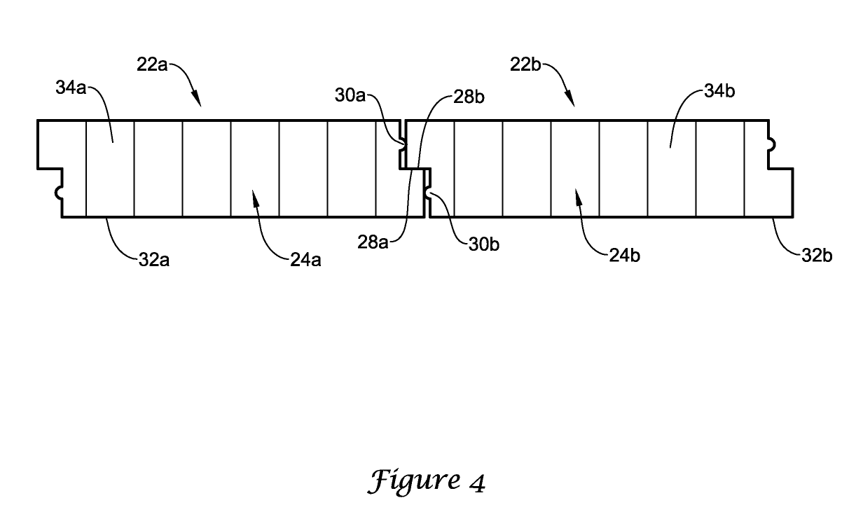

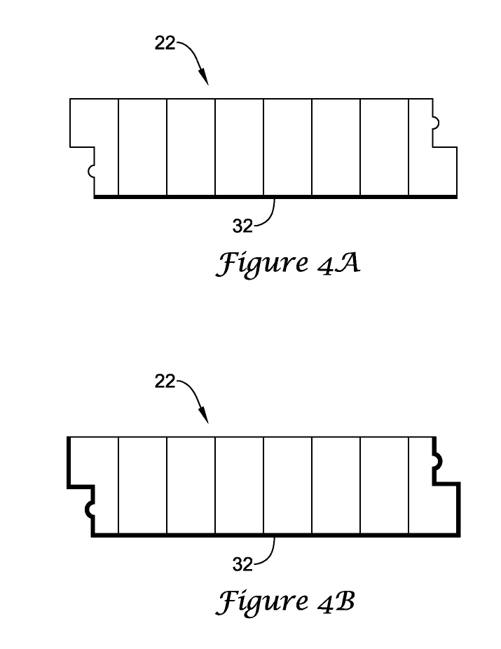

FIG. 4 illustrates a pair of wood members 22 (labeled in FIG. 4 as wood members 22a/22b) that may form a portion of flooring 10. Wood members 22a/22b may include wood strips 24a/24b and may also include a moisture barrier coating 32 (labeled in FIG. 4 as coating 32a/32b on wood members 22a/22b, respectively). Coating 32a/32b may be disposed on a portion of each of wood members 22a/22b. This may include disposing coating 32a/32b on the same regions of wood members 22a/22b. Alternatively, different wood members 22 may have coating 32 along different surfaces and/or portions of surfaces.

In at least some embodiments, coating 32 may be disposed along the bottom surface of one or more wood members 22 as shown in FIG. 4A. This may include disposing coating 32 along the entire bottom surface (e.g., the surface facing the road when flooring 10 is utilized in a truck trailer) of wood member 22 so that 95% or more of the surface area along the bottom surface of wood member 22 includes coating 32, or about 96% or more of the surface area along the bottom surface of wood member 22 includes coating 32, or about 97% or more of the surface area along the bottom surface of wood member 22 includes coating 32, or about 98% or more of the surface area along the bottom surface of wood member 22 includes coating 32, or about 99% or more of the surface area along the bottom surface of wood member 22 includes coating 32, or about 100% of the surface area along the bottom surface of wood member 22 includes coating 32. This may also include disposing coating 32 only along the bottom surface of wood member 22 (e.g., the side surfaces and top surface of wood member 22 are free of coating 32).

In some of these and other embodiments, coating 32 may cover additional portions of wood member 22. For example, coating 32 may extend along portions of the side surfaces of wood member 22 as shown in FIG. 4B. This may include disposing coating 32 along the bottom surface and the side surfaces of wood member 22 so that 95% or more of the surface area along the bottom and side surfaces of wood member 22 includes coating 32, or about 96% or more of the surface area along the bottom and side surfaces of wood member 22 includes coating 32, or about 97% or more of the surface area along the bottom and side surfaces of wood member 22 includes coating 32, or about 98% or more of the surface area along the bottom and side surfaces of wood member 22 includes coating 32, or about 99% or more of the surface area along the bottom and side surfaces of wood member 22 includes coating 32, or about 100% of the surface area along the bottom and side surfaces of wood member 22 includes coating 32.

In some of these and other embodiments, coating 32 may also extend along the top surface of wood member 22. This may include disposing coating 32 along the bottom surface, along the side surfaces, and along the top surface so that 95% or more of the surface area along the bottom, side, and top surfaces of wood member 22 includes coating 32, or about 96% or more of the surface area along the bottom, side, and top surfaces of wood member 22 includes coating 32, or about 97% or more of the surface area along the bottom, side, and top surfaces of wood member 22 includes coating 32, or about 98% or more of the surface area along the bottom, side, and top surfaces of wood member 22 includes coating 32, or about 99% or more of the surface area along the bottom, side, and top surfaces of wood member 22 includes coating 32, or about 100% of the surface area along the bottom, side, and top surfaces of wood member 22 includes coating 32.

Wood members 22 may be 40-60 feet long (e.g., about 56 feet long) and about 10-15 inches (0.83-1.25 feet) wide (e.g., about 12.25 inches or 1.02 feet wide). Accordingly, in the embodiments where coating 32 covers the entire bottom surface of wood member 22, coating 32 may have an area of about 33-75 square feet (e.g., about 57.2 square feet).

The quantity of coating 32 applied to wood members 22 may vary. In at least some embodiments, wood members 22 may include about 8-40 grams of coating 32 per square foot (e.g., about 18-88 pounds per 1000 square feet), or about 10-30 grams of coating 32 per square foot (e.g., about 22-66 pounds per 1000 square feet), or about 4-21 grams of coating 32 per square foot (e.g., about 9-46 pounds per 1000 square feet), or about 15-20 grams of coating 32 per square foot (e.g., about 33-44 pounds per 1000 square feet). These are just examples.

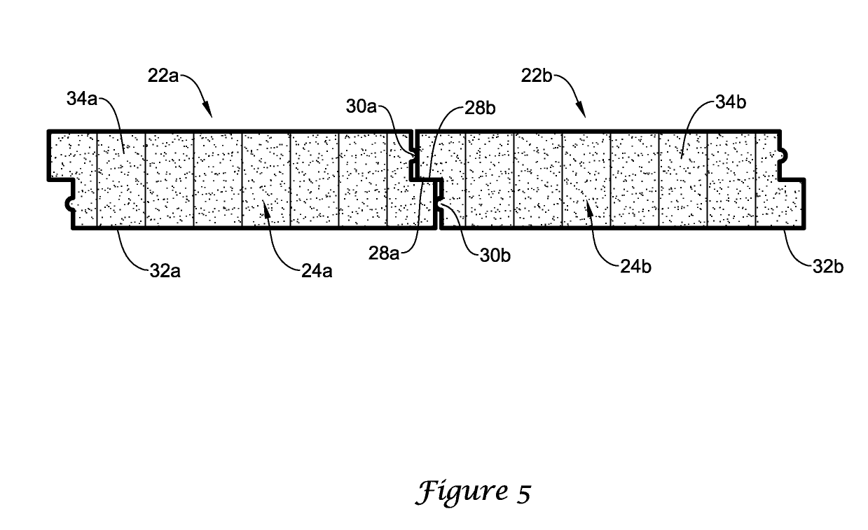

Furthermore, one or more of the end surfaces 34a/34b of wood members 22a/22b may also include coating 32a/32b. For example, FIG. 5 illustrates wood members 22a/22b with end surfaces 34a/34b including coating 32a/32b (represented in FIG. 5 by speckling). This may include disposing coating 32 along the bottom surface, along the side surfaces, along the top surface, and along the end surfaces so that 95% or more of the surface area along the bottom, side, top, and end surfaces of wood member 22 includes coating 32, or about 96% or more of the surface area along the bottom, side, top, and end surfaces of wood member 22 includes coating 32, or about 97% or more of the surface area along the bottom, side, top, and end surfaces of wood member 22 includes coating 32, or about 98% or more of the surface area along the bottom, side, top, and end surfaces of wood member 22 includes coating 32, or about 99% or more of the surface area along the bottom, side, top, and end surfaces of wood member 22 includes coating 32, or about 100% of the surface area along the bottom, side, top, and end surfaces of wood member 22 includes coating 32. In at least some embodiments, wood members 22a/22b may be fully encapsulated by coating 32a/32b.

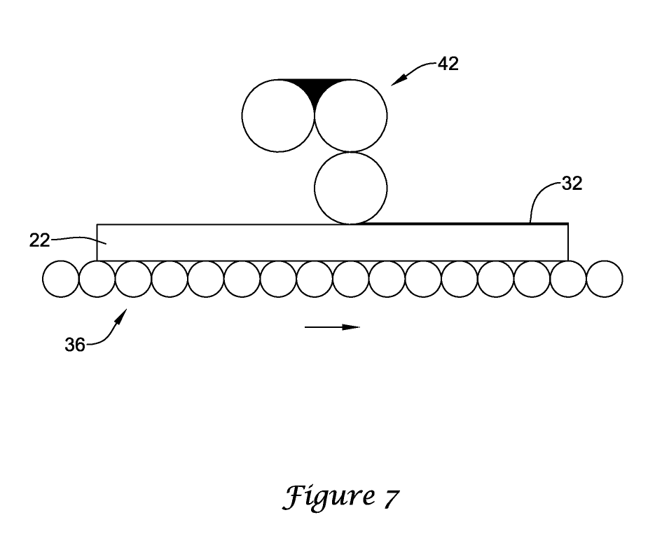

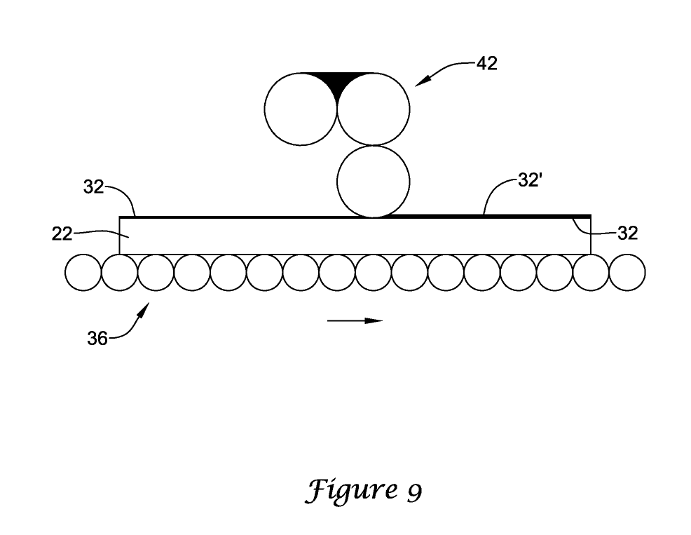

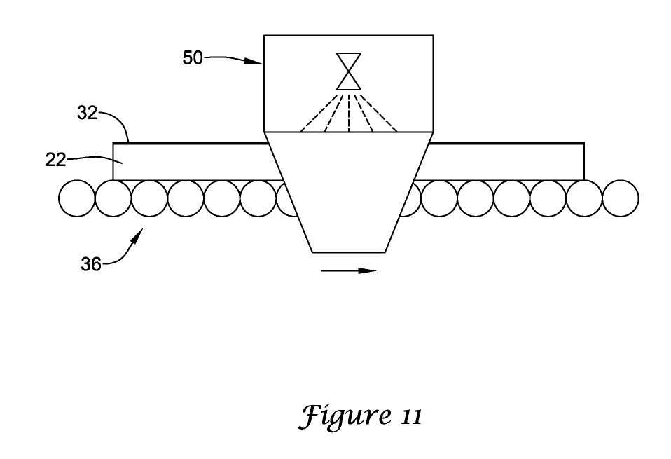

In some embodiments, coating 32 may be applied to wood member 22 using a roller or other suitable coating member (e.g., as shown in FIGS. 7 and 9). Alternatively, coating 32 may be applied to wood member 22 using a sprayer (e.g., as shown in FIG. 11), by mechanical brushing, and/or the like. Other techniques may also be utilized. When applied, coating 32 may have a wet thickness of about 0.005-0.020 inches (e.g., about 0.007-0.010 inches) and a dry thickness of about 0.001-0.010 inches (e.g., about 0.003-0.005 inches). These are just examples.

The form of the coating 32 (e.g., coating 32a/32b) can vary. In at least some embodiments, coating 32 includes crosslinking polyvinyl acetate (and/or polyvinyl acetate). For example, coating 32 may include 50% or more by weight crosslinking polyvinyl acetate, or about 50-95% or more by weight crosslinking polyvinyl acetate, or about 50-80% or more by weight crosslinking polyvinyl acetate, or about 93-95% or more by weight crosslinking polyvinyl acetate. These are just examples.

Polyvinyl acetate is a thermoplastic polymer, which is made from free radical polymerization of the monomer vinyl acetate under an initiator. Commercially available polyvinyl acetate is normally available as an emulsion adhesive that includes polymerized vinyl acetate. The emulsion may also include some fraction of monomers (including vinyl acetate monomers and/or other monomers). These ingredients are further blended with water, a biocide, polyvinyl alcohol, and the like. In order to maintain a good emulsion stability of polyvinyl acetate, a nonionic or anionic surfactant may also be added.

Crosslinking polyvinyl acetate is a two-part adhesive, in which the polyvinyl acetate emulsion is the main part, while the other part is the catalyst or crosslinking agent. Crosslinking polyvinyl acetate can also be a one-part adhesive, in which the catalyst is already premixed. However, the former may provide better wet strength than the latter. By adding a catalyst into the emulsion, polyvinyl acetate, polyvinyl alcohol, and monomer vinyl acetate molecules may react with one another at an ambient or heat condition to form a network structure of crosslinked molecular chains. The curing of crosslinking polyvinyl acetate is driven by a loss of moisture in the emulsion and/or when the moisture is dried out. Compared with regular polyvinyl acetate adhesive, the crosslinked polyvinyl acetate polymer may have a number of desirable properties such as a high bonding strength, excellent water and heat resistances, and the like. The solid content of most commercially available crosslinking polyvinyl acetates may be in a range between 40 and 60% by weight, for example.

In at least some embodiments, the crosslinking polyvinyl acetate itself may be or otherwise include a two-part emulsified phenolic polyvinyl acetate. The two-part emulsified phenolic polyvinyl acetate may include about 10-40% by weight phenol formaldehyde (PF). The use of PF in the two-part emulsified phenolic polyvinyl acetate may improve the thermal resistance of coating 32.

In at least some embodiments, coating 32 may also include a catalyst or modifier, which may promote or otherwise increase crosslinking of the material. A variety of different catalysts may be utilized including chromium nitrate, aluminum nitrate, aluminum chloride, or the like. Some suitable catalysts can be internal crosslinking agents for coating 32, which may include acrylic acid (AA), acrylonitrile (AN), butyl acrylate (BA), glyoxal, dialdehyde glyoxal, glutaraldehyde, hexakis-(methoxymethyl)-melamine (HMMM), iron trichloride, isopropylene alcohol, methyl methacrylate (MMA), N-isobutylmethylol acrylamide (NIBMA), N-methylol acrylamide (NMA), natural rubber latex, potassium bichromate, versate acid VeoVa-10 [(R₁)(R₂)C(R₃)—CO—CH═CH₂], zirconium nitrate [Zr(NO₃)₄], and the like. Other suitable catalysts can also be a mixture of vinyl acetate (VAc) with the above internal crosslinking agents to form a monomer such as VAc/BA, VAc/NIBMA, VAc/NMA, VAc/AA/AN, and the like. These are just examples. Other catalysts are contemplated.

In at least some embodiments, a suitable modifier can be an organic silicone compound such as alkoxysilane, dimethylsiloxane, halogensilane, halogenethylsilane, halo genmethylsilane, halo genmethylphenylsilane, polymethylphenyl silane, vinyltrimethoxysilane, vinyltriisopropoxysilane, and the like. These are just examples.

In at least some embodiments, some suitable modifiers can also include butyl and methyl acrylate esters for monomer vinyl acetate/butyl acrylate. They may be the copolymers of vinyl ester of VeoVa-10, including VeoVa-10/methyl methacrylate, and VeoVa-10/methyl methacrylate/2-ethylhexylacrylate. Another suitable modifier can include the resin of carbamide, melamine, furol, formaldehyde with epoxy. These are just examples.

In at least some embodiments, other suitable modifiers can include adhesives such as aliphatic polyester-phenol formaldehyde (APPF), emulsion polymer isocyanate (EPI), epoxy, furfuryl alcohol-modified urea formaldehyde (FAUA), melamine formaldehyde, melamine urea formaldehyde, phenol formaldehyde, polyester, polymeric diphenylmethane diisocyanate (pMDI), polyisocyanate, urea formaldehyde, and the like. For example, crosslinking polyvinyl acetate itself may be or otherwise include a two-part emulsified phenolic polyvinyl acetate. The use of phenol formaldehyde in the emulsified phenolic polyvinyl acetate may help improve the thermal resistance of coating 32. These are just examples.

In at least some embodiments, coating 32 may include 10% or less by weight of the catalyst or modifier, or about 2-8% by weight of the catalyst or modifier, or about 5-6% by weight of the catalyst or modifier, while coating 32 may contain about 10 to 50% by weight of the adhesive modifier, or about 20 to 25% by weight of the adhesive modifier, or about 35 to 40% by weight of the adhesive modifier. These are just examples.

In some of these and other embodiments, coating 32 may also include a relatively small amount of additives. For example, a mildewcide, fungicide, and/or insecticide such as 3-Iodo-2 propynyl butyl carbamate, 2-(thiocyanomethylthio)benzothiazole/methylene-bis-thiocyanate, 3-iodo-2-propynyl butyl carbamate/chlorpyrifos, alkyl dimethyl benzyl ammonium chloride, alkyl dimethyl ethylbenzyl ammonium chloride, ammoniacal-zinc oxide, azaconazole, bis(tri-N-butyltin oxide)/quaternary amine, coco imidazoline benzyl chloride, copper naphthenate, copper-8-quinolinotate, copper triazole, cypermethrin, deltamethrin, dialkyldimethyl ammonium chloride, didecyl dimethyl ammonium chloride, didecyl dimethyl ammonium chloride/3-iodo-2-propynyl butyl carbamate, imidacloprid, permetrin, propiconazole, sodium pentachlorophenate, tebuconazole, zinc chloride, zinc oxide, or the like may be included (e.g., about 0.2-10% or about 1-4% or so by weight) in coating 32.

A colorant or pigment may also be added to coating 32 (e.g., about 0.05-4% or about 0.5-2% or so) such as carbon black (commercially available from Evonik Industries, Parsippany, N.J.), other black pigments such as SYN-OX HB-1034 and/or HB-1094 (commercially available from Hoover Color, Hiwassee, Va.), or the like may also be added to coating 32. Other colorants that may be utilized may include those commercially available from BASF (Florham Park, N.J.) including CIBA CROMOPHTAL Blue 4GNP, CROMOPHTAL Brown 5R, CROMOPHTAL Red 2020, CROMOPHTAL DPP Red BOC, CROMOPHTAL Pink PT, IRGALITE Green GFNP, IRGALITE Blue BLPO, IRGALITE Black 2B-LN, IRGALITE Red D, IRGALITE Rubine D, IRGALITE Yellow D, or the like. These are just examples.

In some embodiments, coating 32 is made solely of polyvinyl acetate and a catalyst or modifier.

In some embodiments, coating 32 is made solely of crosslinking polyvinyl acetate.

In some embodiments, coating 32 may include emulsion polymer isocyanate (EPI), which may use a 10 to 20% by weight iscocyanate catalyst such as methylene diphenyl diisocyanate (MDI), hexamethylene diisocyanate (HDI), toluene diisocyanate (TDI), isophorone diisocyanate (IPDI), naphthalene diisocyanate (NDI), or the like. These are just examples.

In at least some embodiments, coating 32 defines an outer surface of wood member 22. Accordingly, other structures such as films, coatings, reinforcements, or other structures are not attached to exterior of coating 32. In other words, coating 32 is used as a “coating” and not an adhesive, tie layer, or other intermediate structure.

Coating 32 may be a singular layer of material or, in some embodiments, may include more than one layer. For example, coating 32 may be a single layer of crosslinking polyvinyl acetate. Alternatively, coating 32 may include two or more layers of crosslinking polyvinyl acetate. Each layer may have a dry thickness of about 0.001 to 0.010 inches or about 0.003 to 0.005. Alternatively, the total dry thickness of the two or more layers may be about 0.001 to 0.010 inches or about 0.003 to 0.005. An additional layer or coating of material may be included with coating 32. For example, a layer of latex (e.g., latex based paint) may be applied to coating 32. In some embodiments, the layer of latex material may be applied onto a single layer of crosslinking polyvinyl acetate while in other embodiments the layer of latex may be applied onto two or more layers of crosslinking polyvinyl acetate. Some examples of suitable latex paints may include Daubert TECTYL 2500, commercially available from Daubert Chemical Company, Chicago, Ill., and Sherwin-Williams acrylic A-100 latex paint, commercially available from Sherwin-Williams, Cleveland, Ohio.

The use of crosslinking polyvinyl acetate for coating 32 may be desirable for a number of reasons. For example, crosslinking polyvinyl acetate is a water-based material that can be utilized without the need for harsh organic solvents. Accordingly, the use of crosslinking polyvinyl acetate for coating 32 may allow flooring 10 (and/or the process of manufacturing flooring 10) to be more environmentally friendly.

In addition, crosslinking polyvinyl acetate may be applied to wood members 22 at room temperature. This allows the manufacturing process to be simplified or otherwise be performed without the need for various heating steps or high temperature application conditions that may be required, for example, if hot melt materials were used. Alternatively, if heating steps are utilized, the heating may be attenuated (e.g., a relatively small increase in temperature) in comparison to the heating required through the use of other materials.

Other features and benefits may also be realized through the use of crosslinking polyvinyl acetate. For example, a crosslinking polyvinyl acetate coating 32 may add relatively little weight to flooring 10 (e.g., about 8-40 grams of coating 32 per square foot, or about 10-30 grams of coating 32 per square foot, or about 15-20 grams of coating 32 per square foot). In addition, a crosslinking polyvinyl acetate coating 32 may have some flexibility and/or resiliency such that flexure of flooring 10 is less likely to break and/or chip coating 32. This may improve the durability and/or lifespan of flooring 10. Furthermore, crosslinking polyvinyl acetate may add fewer manufacturing costs to floorings, which results in a more affordable flooring 10 for consumers. One or more coats of crosslinking polyvinyl acetate are also effective as a moisture barrier and reduce water absorption into floor boards. In addition, when compared to a more conventional latex-based coating that can be applied to a floor board, crosslinking polyvinyl acetate is less likely to delaminate adjacent to the joints of the wood strips of a floor board. Crosslinking polyvinyl acetate may also provide better protection of wood member from fungi, insects, and mildews. These are just examples. Other desirable features and benefits may also be achieved through the use of a crosslinking polyvinyl acetate coating 32.

Coating 32 may be a commercially available crosslinking PVAc adhesive such as Adhpro 30224 (Adhpro Adhesives Inc., Magog, Quebec, Canada), Adhpro 30529 (Adhpro Adhesives Inc., Magog, Quebec, Canada), Adhpro 30530 (Adhpro Adhesives Inc., Magog, Quebec, Canada), CL-1809HV (National Casein Company, Chicago, Ill.), Helmibond 805 (Helmitin, Inc., Oliver Branch, Miss.), Multibond SK-8 (Franklin International, Columbus, Ohio), Mowlith 2440 (Coatings & Resins International Ltd, Auckland, New Zealand), Multibond 2000 (Franklin International, Columbus, Ohio), PC-2002 (National Casein Company, Chicago, Ill.), Racal 2375 (Coatings & Resins International Ltd, Auckland, New Zealand), Wonderbond WB-957 (Momemtive, Columbus, Ohio), Wonderbond XB-90MI (Momemtive, Columbus, Ohio), WP-2200 (National Casein Company, Chicago, Ill.), and the like. These are just examples.

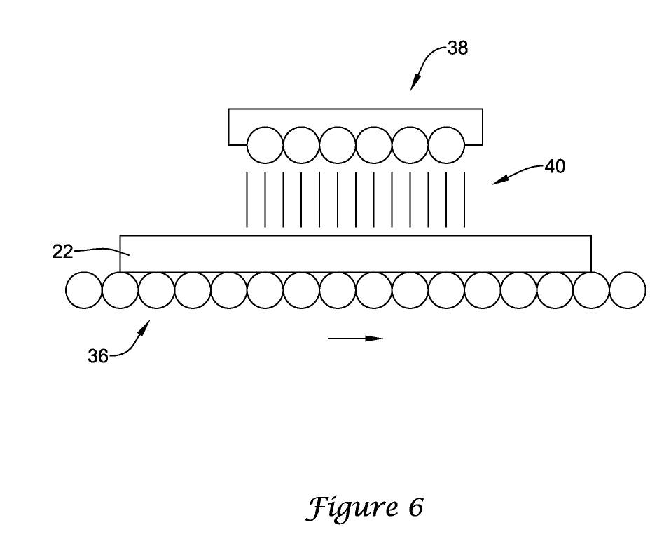

FIGS. 6-13 illustrate some example methods for coating wood member 22 (and/or for producing flooring 10 with coating 32 on wood members 22). For simplicity purposes, the following discussion makes reference to a single wood member 22. It can be appreciated that assembly of flooring 10 incorporates a plurality of wood members 22.

Prior to coating, each wood member 22 may be sanded or otherwise smoothened (e.g., using a sander, planer, or the like). In at least some embodiments, it may be desirable for wood member 22 to have a relatively small surface roughness (e.g., 0.001-0.003 inches). In addition, the moisture content of the wood within wood member 22 may be adjusted to a suitable level. This may include drying wood member 22 (e.g., placing wood member 22 in a controlled moisture environment and/or using a suitable drying apparatus).

Wood member 22 may be “preheated” prior to coating. This may include exposing wood member 22 to a heating apparatus 38. In at least some embodiments, heating apparatus 38 (e.g., as shown in FIG. 6) may be an infrared (IR) heater. The set temperature of the IR heater can be in a range of about 400 to 600° F. (e.g., the heating head of heating apparatus 38 may have a heating density of about 10 W/in² or so). This is just an example. While heating, a heating zone 40 may be defined by placing heating apparatus 38 adjacent to wood member 22. For example, heating apparatus 38 (e.g., a heading head thereof) may be disposed approximately 0.5 to 18 inches (e.g., about 0.5 to 6 inches) away from the surface of wood member 22 and define heating zone 40 therebetween. In at least some embodiments, the preheating process may be a stationary process where wood member 22 or the heating process may include passing wood member 22 through heating apparatus 38 with, for example, a conveyor or other supporting member 36. In at least some embodiments, preheating may heat wood member 22 so that the wood surface temperature reaches about 80 to 210° F., or about 80 to 180° F., or about 130 to 160° F. Preheating may occur over a suitable amount of time, which may be, for example, about 1 second to ten minutes or so (e.g., 1 second to two minutes or so) for wood member 22 to pass through heating apparatus 38, depending on the heating density used. However, preheating may not be required.

In order to avoid overheating or surface burning during the preheating process, fans may be used, for example, underneath or adjacent to the heating head of heating apparatus 38 to improve heat circulation at the surface of wood member 22. The air circulation direction (e.g., orientation of the fans) can be vertical or horizontal relative to the coated surface of wood member 22. Air circulation over and across the coated surface of wood members 22 (e.g. horizontally oriented air circulation) may also help dry wood member 22, which may also be desirable.

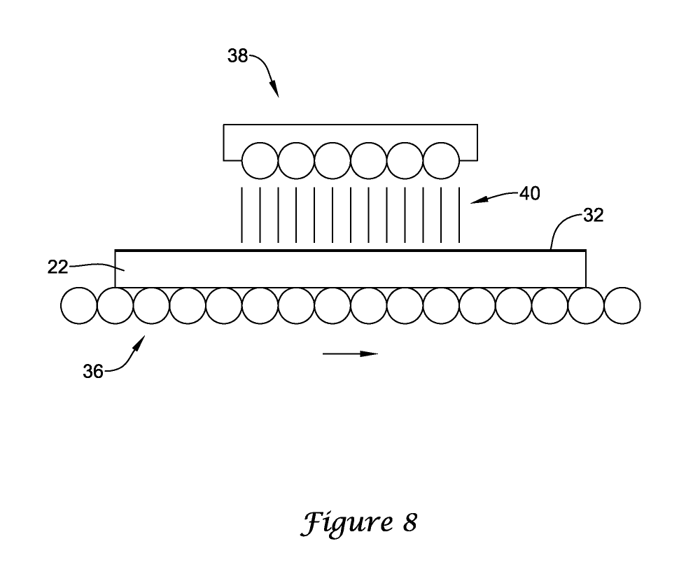

FIG. 7 illustrates the use of a roller 42 to apply coating 32 onto wood member 22. Coating 32 may be applied to wood member 22 in standard room conditions (e.g., at room temperature). In other words, coating 32 need not be heated during prior to or during application. Following the application of coating 32, wood member 22 may be again heated using heating apparatus 38 (or another suitable heating apparatus), which may help rapidly evaporate any volatile parts of coating as illustrated in FIG. 8. Both stationary and continuous drying processes may be used for this heating step. The setup of IR heating for coating 32 can be referenced to the aforementioned preheating process. In addition, a set of fans or a ventilation system may be used to help remove the moisture from coating 32 during drying, which may result in a uniform coating film on wood member 22. In at least some embodiments, the heating temperature, heating distance and surface temperature of coating 32 may be appropriately adjusted, as needed. However, heating may not be required. Optionally, a second layer of coating 32 (shown as coating 32′ in FIG. 9) may be applied to wood member 22 as shown in FIG. 9. While other figures included with this disclosure may show coating 32 (e.g., as a “single layer”), it can be appreciated that these figures may also include a second layer (e.g., coating 32′) or otherwise include a plurality of layers.

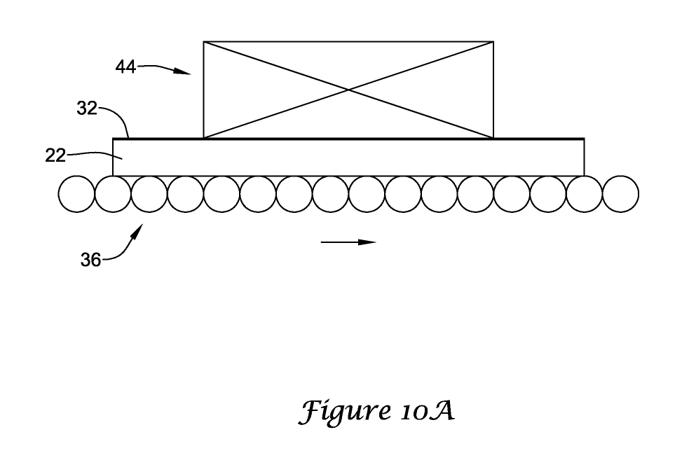

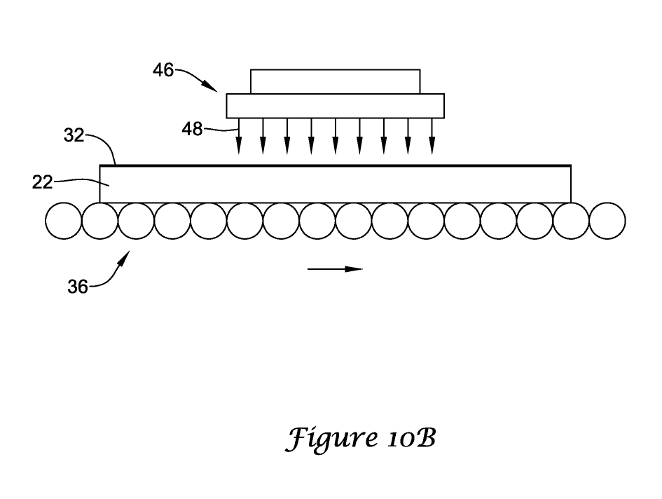

When wood member 22 is suitable coated, wood member may be disposed in a press 44 (e.g., a RF press) as shown in FIG. 10A. In order to easily release wood member 22 from press 44 after pressing, a mold release like emulsified paraffin wax or organic oil can be spread on coating 32 before it enters press 44. While in the press, coating 32 may be heated while applying a pressure of about 10 to 150 psi (e.g., about 10 to 80 psi) to cure coating 32. The curing time may be about 30 seconds to 5 minutes (e.g., about 30 seconds to 2 minutes) within press 44 (which may almost completely cure coating 32). Alternatively, coating 32 can be cured with a continuous drying process as shown in FIG. 10B. This may include passing wood member 22 through a continuous RF or IR curing tunnel 46, which may provide energy 48 (and/or heat) to promote curing. The speed of conveyor 36 while wood member 22 is in curing tunnel 46 may be set so that coating 32 reaches a curing rate of about 80% or more before the wood member 22 exits tunnel 46.

In at least some embodiments, one or more additional steps may also be utilized. For example, FIG. 11 illustrates that coating 32 can be further coated (e.g., with a latex or other coating) by passing wood member 22 through a sprayer 50. The wet thickness of the latex layer may be about 0.005 to 0.010 inches. The hot surface of the coated wood member 22 after exiting from either press 44 or tunnel 46 may help evaporate the moisture of the latex coating and accelerate its curing speed. The heating/curing time for one coat may be about 5 to 7 min. The total heating/curing time for two coats may be around 15 min. The total coating amount may be controlled to be about 8-40 grams of coating 32 per square foot, or about 10-30 grams of coating 32 per square foot, or about 15-20 grams of coating 32 per square foot.

Wood member 22 may also be assessed for quality control to determine whether or not the desired thickness of coating 32 is disposed on wood member 22. This may include the use of a suitable measuring tool or coating gauge. For example, it may be desirable for coating 32 to have a dry thickness of about 0.001-0.010 inches (e.g., about 0.003-0.005 inches).

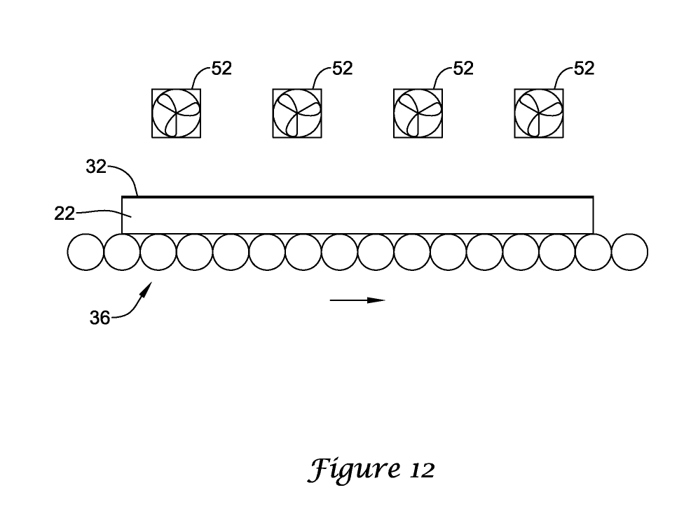

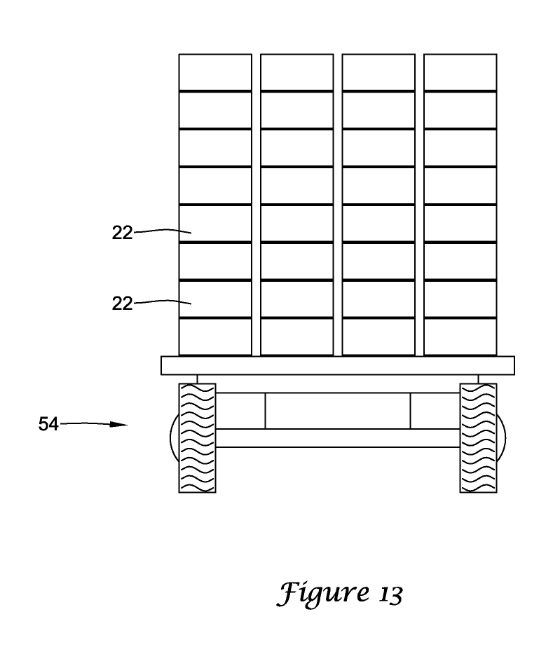

Wood member 22 may enter a temporary storage station as shown in FIG. 12. Here, fans 52 may be directed at wood member 22 (or a plurality of wood members 22) so that, for example, moisture can be removed. The ventilation helps accelerate further curing of the adhesive or latex coating. The temperature storage and/or fanning may take place over any suitable amount of time such as about 20 min. When suitably fanned, a plurality of wood members 22 may be stacked and/or stored in a suitable storage facility and when appropriate may be packaged for shipping on a truck 54 as shown in FIG. 13.

The above procedures can be modified in a number of ways including ways that may improve the process for the production of trailer flooring. For example, one or more steps can be omitted and/or some of the steps can be rearranged to best suit the overall cost, production and coating durability of a given project. In one example embodiment, wood members 22 can be heated initially with heating apparatus 38 and then sprayed with the coating 32 material with sprayer 50. The resultant floorboards with coating 32 may be packed after drying. In some embodiments, only a single layer of coating 32 may be applied to wood member 22 and the curing process may be accelerated with a hot press or at room conditions. The cured coating 32 can be further coated with latex. For example, coating 32 can be a coating layer combination of crosslinking polyvinyl acetate, EPI, and latex. The first layer may be crosslinking polyvinyl acetate and EPI, respectively, while the exterior layer may be latex and crosslinking polyvinyl acetate, respectively. As indicated above, colorants (or pigments), mildewcides, fungicides, insecticides, and the like can be added to coating 32, as desired, in order to provide its aesthetic appearance and better exterior performance.

### EXAMPLES

The invention may be further clarified by reference to the following Examples, which serve to exemplify some of the preferred embodiments, and not to limit the invention in any way.

### Example 1

An example coating was made that included 100 parts polyvinyl acetate (commercially available from Franklin International, Columbus, Ohio) and 6 parts chromium nitrate.

### Example 2

An example coating was made that included 100 parts of a two-part emulsified phenolic polyvinyl acetate (commercially available from Momentive, Columbus, Ohio) and 5 parts aluminum nitrate.

### Example 3

An example coating was made that included 100 parts polyvinyl acetate (commercially available from Franklin International, Columbus, Ohio), 6 parts chromium nitrate, and 0.5 part carbon black (commercially available from Evonic, Parsippany, N.J.).

### Example 4

An example coating was made that included 100 parts polyvinyl acetate (commercially available from Franklin International, Columbus, Ohio), 6 parts chromium nitrate, and 2 parts (based on the total weight of the coating) mildewcide (3-Iodo-2 propynyl butyl carbamate, commercially available from Dow Chemical, Midland, Mich.).

### Example 5

An example coating was made that included 100 parts polyvinyl acetate (commercially available from Franklin International, Columbus, Ohio), 6 parts chromium nitrate, 0.5 part (based on the total weight of the coating) carbon black (commercially available from Evonic, Parsippany, N.J.), and 2 parts (based on the total weight of the coating) mildewcide (3-Iodo-2 propynyl butyl carbamate, commercially available from Dow Chemical, Midland, Mich.).

### Example 6

The coatings from Examples 1-5 were tested using a gravelometer to evaluate the chipping resistance of the coatings. The coatings were applied (as either a single layer of the coating or as a double layer of the coating) to a 5 inch by 12 inch sample oak floor board. The coatings from Examples 1-2 (single layer and double layer) were also tested with an exterior coating of latex paint (Daubert TECTYL 2500, commercially available from Daubert Chemical Company, Chicago, Ill.). The testing included shooting 1 pint of standardized road gravels onto the coated wood surface in accordance with SAE standard SAE J400. The gravelometer contains road gravel, a test panel holder, and a gravel projector. Before the test, the sample oak floor boards using the coatings from Examples 1-5 were frozen at −20° F. for 4 hours. The sample floor boards were vertically placed at the sample holder with a distance of 21.75 inches from the gravel projector. During the test, a pint of gravel rocks were projected within 7 to 10 seconds under an air pressure of 70 psi.

After projecting the gravel, the sample floor boards were allowed to return to room temperature and dried with a soft cloth to remove any condensed moisture, dust and other contaminants. The tested area of the sample floor boards were covered with multiple strips of duct tape side-by-side. The tapes were firmly adhered to the tested sample floor boards by applying uniform pressure. The tapes were then removed by pulling straight up to remove any loose chips or paints. After the test, the chipping patterns of the tested panels were evaluated using the chipping rating standard SAE J400. The sample floor boards using the coatings from Examples 1-5 (including single layers, double layers, and coating with an exterior layer of latex paint) all passed the chipping resistance requirement by SAE J400.

### Example 7

One layer of the coating from Example 1 was applied to a 5 inch by 12 inch sample oak floor board. Two layers of the coating from Example 1 were also applied to a 5 inch by 12 inch sample oak floor board. Water absorption in sample oak floor boards was measured over time by soaking the sample floor boards in water tanks The sample floor boards were kept at 1 inch below the water line during testing. The water absorption in the sample oak floor boards was compared with control (either uncoated or latex coated sample oak floor boards, which may be similar to commercially available floor boards). The results were summarized in Table 1.

TABLE 1
Moisture Resistance of Coated Wood Members

| | Water | | |
|---|---|---|---|
| | Absorption | Water Absorption | Water Absorption |
| Coating | (%) after 1 Day | (%) after 3 Days | (%) after 7 Days |
| Control 1 | 2.63 | 4.25 | 8.03 |
| Control 2 | 1.85 | 3.35 | 5.54 |
| Example 1 - One | 0.97 | 1.75 | 2.80 |
| layer | | | |
| Example 1 - Two | 0.93 | 1.59 | 2.56 |
| layers | | | |

Control 1: Uncoated sample floor boards.
Control 2: Latex-coated sample floor boards.

The results indicate that the coatings from Example 1 (one layer and two layers) provide better resistance to moisture than control floorboards.

### Example 8

Emulsified paraffin wax, which represents a commercially-available coating used for end-sealing floor boards, and the coating from Example 1 were applied to seal the ends of 5 inch by 12 inch sample oak floor boards. Before testing, all other (e.g., non-end) surfaces of wood members were bonded with a high pressure melamine laminate sheet so that water ingress is only allowed through the end surfaces. Water absorption was measured over time for the sample oak floor boards by soaking them in water tanks The sample oak floor boards were kept at 1 inch below the water line during testing. The results were summarized in Table 2.

TABLE 2
Moisture Resistance of End Sealed Wood Members

| | Water Absorption | Water Absorption | Water Absor ption |
|---|---|---|---|
| Coating | (%) after 1 Day | (%) after 3 Days | (%) after 7 Days |
| Control 1 | 3.93 | 7.03 | 11.55 |
| Control 2 | 2.42 | 5.19 | 9.31 |
| Example 1 | 1.09 | 2.03 | 3.43 |

Control 1: No coating on both ends of sample floor boards.
Control 2: Both ends of the sample floor boards coated with emulsified parafin wax.

The results indicate that the coating from Example 1 provides better resistance to water and/or moisture than emulsified paraffin wax.

### Example 9

Sample floor boards were made that included the coatings from Examples 1-4 (one layer or two layers of the coating), along with sample floor boards with the coating from Examples 1, 3 and 4 plus an exterior layer of latex paint (Daubert TECTYL 2500, commercially available from Daubert Chemical Company, Chicago, Ill.), and sample floor boards coated with latex paint as a control were placed in an outside Minnesota environment. During the field testing, the sample floor boards were placed horizontally on wood frames and tilted with an angle in order to help drain moisture and rain away the coating. The coated surfaces (if present) were arranged “face up”.

In one test group, the sample floor boards were simply placed on the racks. This test group included a control maple floor board 21 inches by 12 inches coated with latex paint, a sample maple floor board 22.5 inches by 12 inches coated with the coating from Example 1 and also painted with latex paint, and a sample oak floor board 12 inches by 12 inches coated with the coating from Example 2 (two layers). After 10 months, approximately 30% of the latex paint on the control board was peeled off and serious delamination of the floor board along glue lines between adjacent wood strips was observed for the control floor board. After 33 months, the coating on the sample floor board using the coating from Example 1 with and without latex paint and Example 2 was intact and showed no signs of delamination along glue lines between adjacent wood strips.

In another test group, the sample floor boards were fastened to the racks by screws. This test group included a control oak floor board 36 inches by 12 inches coated with latex paint, a sample oak floor board 36 inches by 12 inches coated with the coating from Example 1, two sample maple floor boards 36 inches by 12 inches each coated with two layers of the coating from Example 1, a sample oak floor board 36 inches by 12 inches coated with the coating from Example 1 and also painted with latex paint, a sample oak floor board 6 inches by 10 inches with Examples 3 and 4, respectively, and a sample oak floor board 6 inches by 10 inches with Examples 3 and 4 and also painted with latex paint, respectively. After 20 months, approximately 40% of the latex paint on the control board was peeled off and serious delamination of the floor board along glue lines between adjacent wood strips were observed for the control floor board. After 10 months, the coating on the sample floor board using the coating from Examples 1, 3 and 4, respectively, was intact and showed no signs of delamination along glue lines between adjacent wood strips. After 20 months, the coating on both the sample floor boards using the coating from Examples 1, 3 and 4, respectively, was intact and showed no signs of delamination along glue lines between adjacent wood strips. After 10 months, the coating on the sample floor board using the coating from Examples 1, 3 and 4 and also painted with latex paint, respectively, was intact and showed no signs of delamination along glue lines between adjacent wood strips.

Collectively, these test results indicate that floor boards coated with the coatings from Examples 1-4 (including samples that utilized more than one coat of the coating and/or latex paint) showed enhanced durability (including resistance to delamination) and weather resistance.

It should be understood that this disclosure is, in many respects, only illustrative. Changes may be made in details, particularly in matters of shape, size, and arrangement of steps without exceeding the scope of the invention. The invention's scope is, of course, defined in the language in which the appended claims are expressed.

1. A wood floor for truck trailers and containers, comprising:
a wood member having a top surface and a bottom surface, wherein the wood member includes a plurality of wood strips that are attached together;
a coating essentially impermeable to liquid water and water vapor covering the bottom surface and sealing the bottom surface; and
wherein the coating includes crosslinking polyvinyl acetate.

2. The wood floor of claim 1, wherein the coating consists essentially of crosslinking polyvinyl acetate.

3. The wood floor of claim 1, wherein the coating consists of crosslinking polyvinyl acetate.

4. The wood floor of claim 1, wherein the coating has a dry thickness of 0.001 to 0.010 inches.

5. The wood floor of claim 1, wherein the coating has a dry thickness of 0.003 to 0.005 inches.

6. The wood floor of claim 1, wherein the coating covers the entire bottom surface of the wood member.

7. The wood floor of claim 1, wherein the wood member includes opposing side surfaces and opposing end surfaces, and wherein the coating covers the opposing side surfaces and the opposing end surfaces.

8. A wood floor for truck trailers and containers, comprising:
a wood floor having a bottom surface, the wood floor including a plurality of floor boards;
wherein each of the floor boards include a plurality of wood strips that are attached together;
a coating covering the bottom surface;
wherein each of the floor boards include opposing side surfaces and wherein the coating extends along the opposing side surfaces; and
wherein the coating includes crosslinking polyvinyl acetate.

9. The wood floor of claim 8, wherein the coating consists essentially of crosslinking polyvinyl acetate.

10. The wood floor of claim 8, wherein the coating consists of crosslinking polyvinyl acetate.

11. The wood floor of claim 8, wherein the coating has a dry thickness of 0.001 to 0.010 inches.

12. The wood floor of claim 8, wherein the coating has a dry thickness of 0.003 to 0.005 inches.

13. The wood floor of claim 8, wherein the coating covers the entire bottom surface of each of the floor boards.

14. The wood floor of claim 8, wherein each of the floor boards include a top surface and opposing end surfaces, and wherein the coating covers the top surface, the opposing side surfaces, and the opposing end surfaces of each of the floor boards.

15. A method for manufacturing a wood floor, the method comprising:
providing a plurality of wood strips;
attaching the wood strips together to form a floor board;
coating a bottom surface of the floor board with crosslinking polyvinyl acetate;
wherein coating the bottom surface of the floor board seals the bottom surface of the floor board; and
forming a wood floor by joining together two or more floor boards.

16. The method of claim 15, wherein coating a bottom surface of the floor board with crosslinking polyvinyl acetate includes roller coating.

17. The method of claim 15, wherein coating a bottom surface of the floor board with crosslinking polyvinyl acetate includes mechanical brushing, spray coating, or both.

18. The method of claim 15, wherein coating a bottom surface of the floor board with crosslinking polyvinyl acetate includes heating the floor board.

19. The method of claim 15, wherein coating a bottom surface of the floor board with crosslinking polyvinyl acetate includes disposing two or more layers of crosslinking polyvinyl acetate along the bottom surface of the floor board.

20. The method of claim 15, wherein coating a bottom surface of the floor board with crosslinking polyvinyl acetate includes spray coating the entire bottom surface of the floor board.
